(19) United States
(12) Patent Application Publication
(10) Pub. No.: US 2022/0103434 A1
(43) Pub. Date: Mar. 31, 2022

(54) METHODS AND APPARATUS FOR PROPAGATING OPERATION DATA TO ONE OR MORE DEVICES

(71) Applicant: Arm IP Limited, Cambridge (GB)

(72) Inventors: Marianne Elizabeth Julie CROWDER, Cambridge (GB); Thomas Christopher GROCUTT, Cambridge (GB)

(21) Appl. No.: 17/310,003

(22) PCT Filed: Dec. 19, 2019
(86) PCT No.: PCT/GB2019/053635

§ 371 Date: Jul. 9, 2021

(30) Foreign Application Priority Data
Jan. 11, 2019 (GB) 1900383.9

(51) Int. Cl. H04L 41/16; H04L 41/08; H04L 41/28

(52) U.S. Cl. CPC H04L 41/16; H04L 41/28; H04L 41/0889; H04L 41/0883

(57) ABSTRACT

A network management module receives requests for operation data from a device and determines a response to be sent to the device indicative of an user's responses to prior operation data requests. The user's responses to operation data requests are shared by the network management module with one or more devices, reducing the number of responses required directly from the user. In addition, the user responses to operation data requests from a first device may be used to derive the user's response to other operation data requests from the same device or from one or more different devices, of the same or different type.

The present techniques relate to methods and apparatus for propagating operation data to one or more devices connected to a network. More particularly, the techniques relate to methods and apparatus for deriving responses to operation data requests from the user's previous responses to operation data requests, and providing the derived response to one or more devices connected to a network.

More and more devices are being connected, for example, as part of the Internet of Things (IoT). Numerous different devices may be connected to the same network, ranging from relatively small devices such as temperature sensors, lightbulbs, light switches, healthcare monitors, electronic door locks, etc. to relatively large devices, such as music systems, fridges, heating system thermostats etc. Each device requires a user to provide user inputs in response to policy requests and/or configuration requests at least once. However, this can be irksome to users when a lot of devices are connected to their network and the policy requests and/or configuration requests from the various different devices are the same or very similar requiring the user to respond to the same/similar requests numerous times.

According to a first technique, there is provided a computer implemented method for propagating operation data relating to operation of at least one device. The method comprising: receiving, at a network management module, a device request for operation data in relation to operation of one or more devices, from a device, the network management module comprising logic to determine how to respond to the device request by: providing at least one repository query to a repository for data relating to the device request, the repository configured to store response data indicative of user responses to prior user requests derived from prior device requests; and when the logic is unable to determine based on at least one received response to the at least one repository query how to respond to the device request, transmitting, to a user interface, a user request for a user response, wherein the user request is derived from the device request; and in response to receiving the user response to the user request, providing to the repository new data indicative of the user response and providing to the device a response to the device request derived from the user response.

According to a second technique, there is provided a computer readable storage medium comprising computer program code for performing the methods described herein.

According to a third technique, there is provided a network management module for propagating operation data relating to operation of at least one device. The network management module comprising a communication module for receiving, a device request, created by the device, for operation data in relation to operation of one or more devices; and logic for providing, to a repository, at least one repository query for data relating to the device request, the repository configured to store repository data indicative of user responses to prior user requests derived from prior device requests, for determining how to respond to the device request based on at least one received response to the at least one repository query, and for providing, to a user interface, a user request for a user response to the device request when the logic is unable to determine how to respond to the device request; wherein, in response to receiving the user response to the user request, the logic provides to the repository new data indicative of the user response and provides to the device a response to the device request derived from the user response.

According to a fourth technique, there is provided a system for propagating operation data relating to operation of at least one device. The system comprising: at least one device; and a network management module for receiving a device request for operation data in relation to operation of one or more devices, from at least one device, the network management module comprising logic to determine how to respond to the device request by: providing at least one repository query to a repository for data relating to the device request, the repository comprising response data indicative of user responses to prior user requests derived from prior device requests; and when the logic is unable to determine based on at least one received response to the at least one repository query how to respond to the device request, providing, to a user interface, a user request for a user response derived from the device request; and in response to receiving the user response to the user request, providing to the repository new data indicative of the user response and providing to the at least one device a response to the device request derived from the user response.

Embodiments will now be described with reference to the accompanying figures of which:

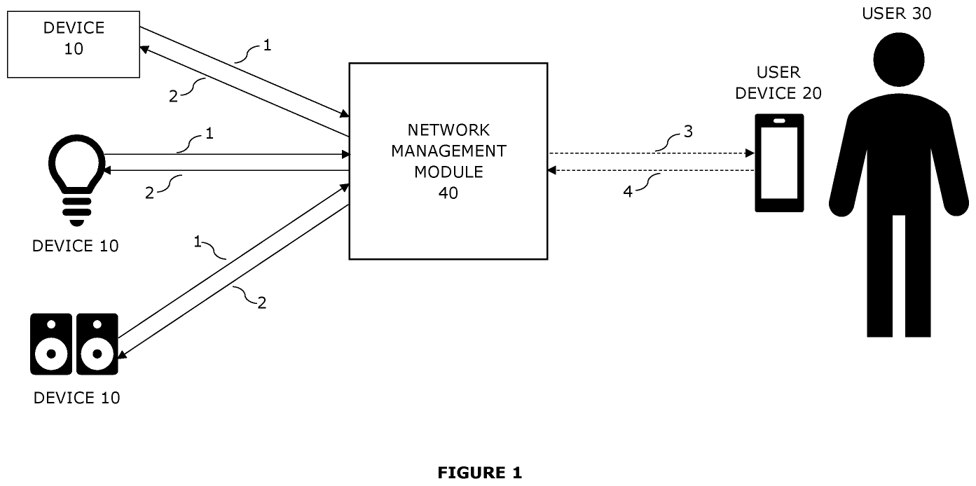

FIG. 1 illustrates schematically a system for propagating operation data to one or more devices;

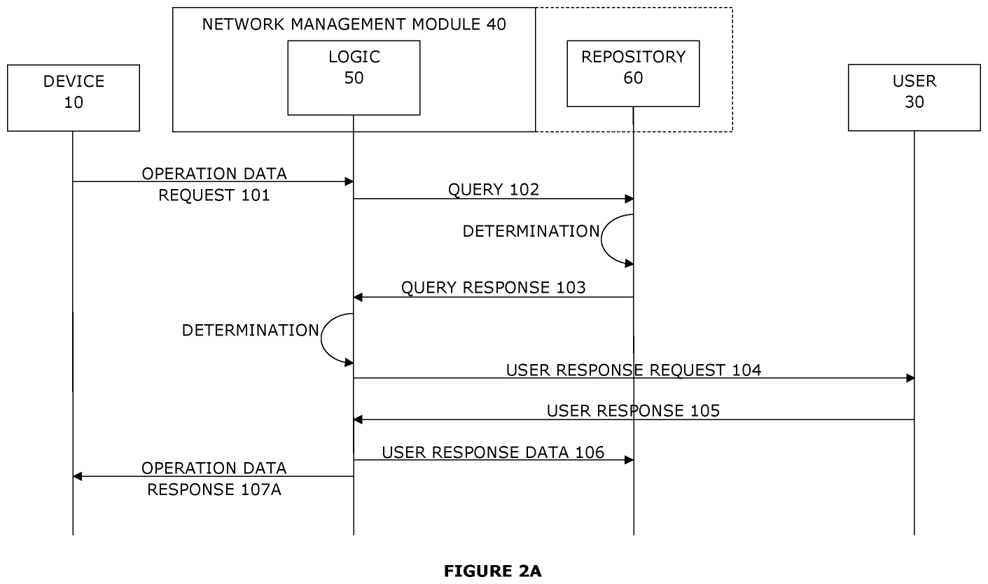

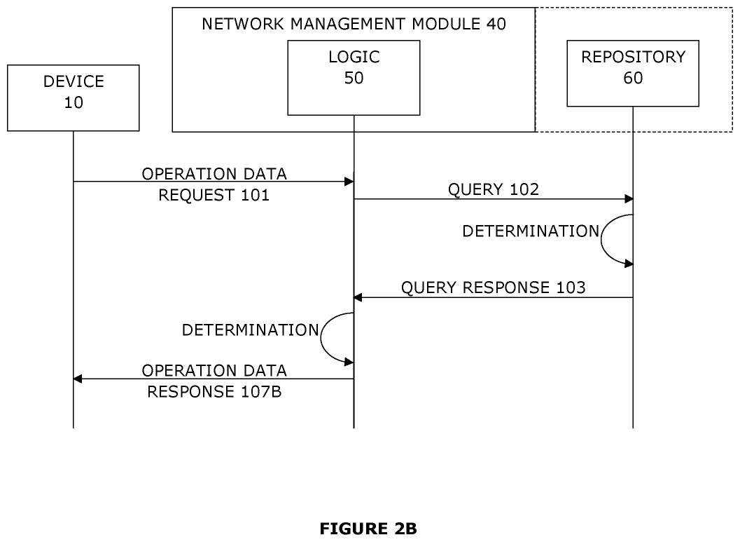

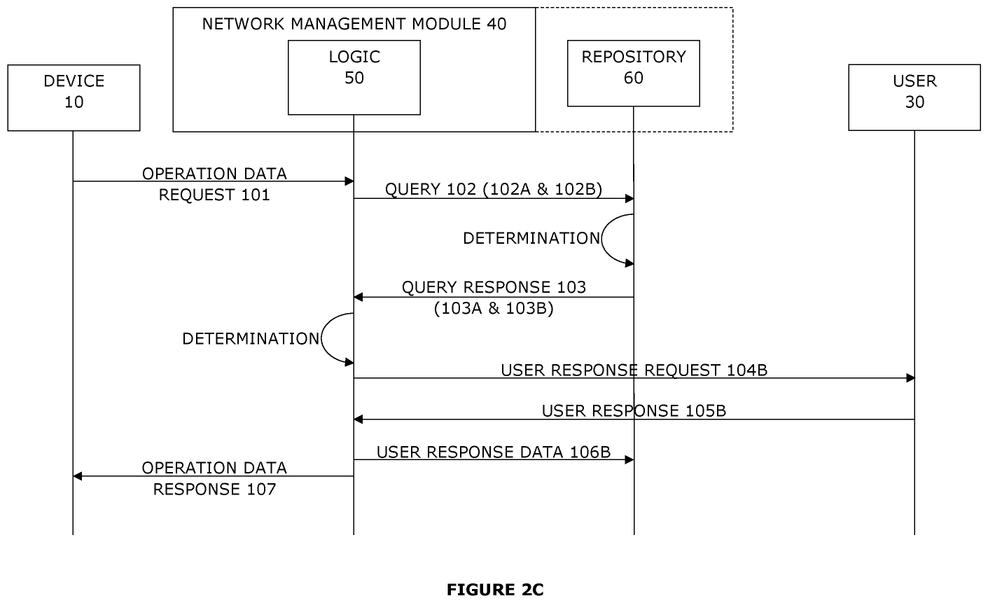

FIG. 2A illustrates a communication flow diagram of a method described herein;

FIG. 2B illustrates another communication flow diagram of a method described herein;

FIG. 2C illustrates another communication flow diagram of a method described herein;

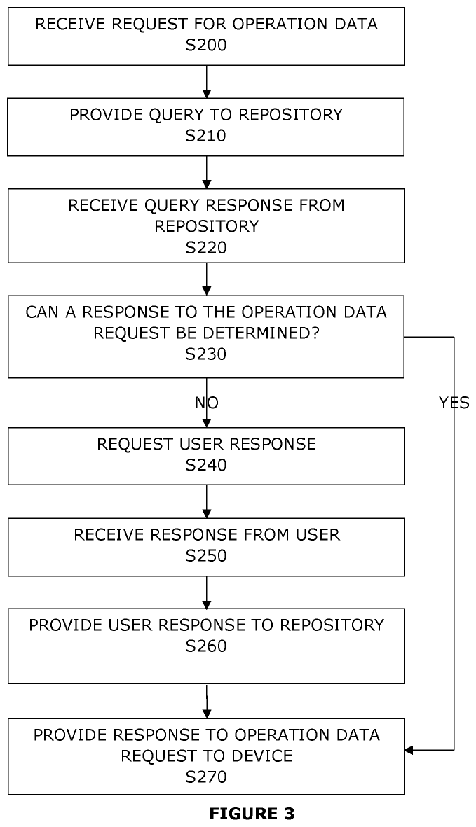

FIG. 3 illustrates schematically a method for propagating operation data to one or more devices;

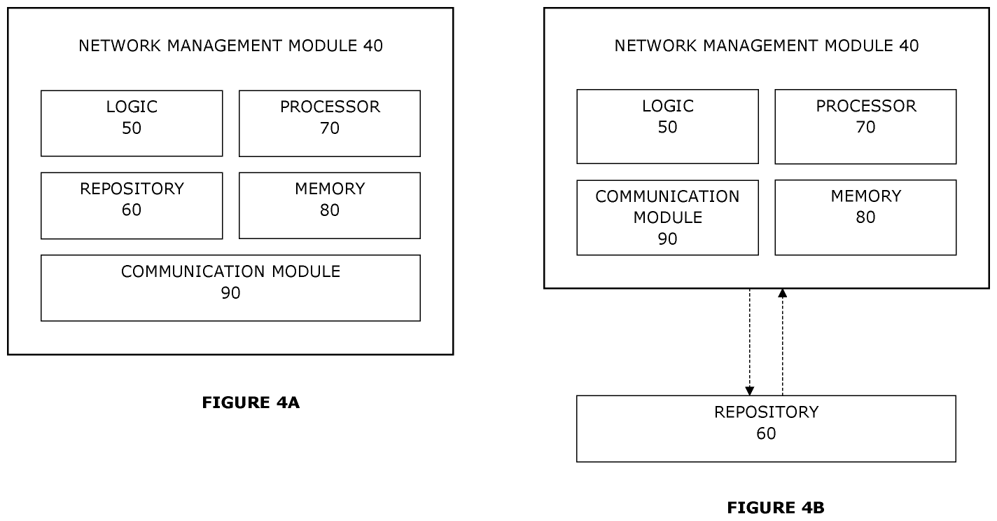

FIG. 4A illustrates schematically a network management module; and

FIG. 4B illustrates schematically another network management module.

A method for propagating responses to operation data requests is described herein. Operation data may be any data which has an effect on the operation of a device. According to one embodiment, the operation data may comprise policy data, such as an acceptance of the device's terms and conditions, and the response to a policy data request affects the operation of the device. According to another embodiment, the operation data may comprise configuration data, and the response to the configuration data request affects the operation of the device. According to another embodiment, the operation data may comprise permission data, and the response to the permission data request affects the operation of the device, for example, the permission data may define what data may or may not be transmitted to third parties. According to another embodiment, the operation data may comprise permission data and the permission being sought defines how and/or to what extent a third party (such as the device manufacturer) is permitted to use data transmitted to the third party from the device, and who the third party is permitted to share the data with. According to this embodiment, the permission data may be forwarded unaltered to the third party. However, the permission data may still be considered operation data since the permission data defines the operation of the device in operating to share data (if any) with the third party.

A network management module receives requests for operation data from a device and determines a response to be sent to the device derived from a user's responses to prior operation data requests. The user's responses to operation data requests are used by the network management module to generate responses to be shared with one or more devices, reducing the number of responses required directly from the user. In addition, the user responses to operation data requests from a first device may be used to derive the response to other operation data requests from the same device, or one or more different devices of the same or different type.

Reference will now be made in detail to the embodiments, examples of which are illustrated in the accompanying figures. In the following detailed description numerous specific details are set forth by way of examples in order to provide a thorough understanding of the relevant teachings. However, it will be apparent to one of ordinary skill in the art that the present teachings may be practiced without these specific details.

In other instances, well known methods, procedures, components and/or circuitry have been described at a relatively high-level, without detail, in order to avoid unnecessarily obscuring aspects of the present teachings.

FIG. 1 illustrates schematically a system for propagating operation data to one or more devices 10. The devices 10 may be any device connected to a network for which a network management module 40 is provided. The devices may be smart lightbulbs, temperature sensors, light switches, music speakers, smart fridges, healthcare monitors, electronic door locks, thermostats etc. According to another embodiment, one or more of the devices 10 may be a virtual device, a virtual device being an isolated software module, for example a virtual machine or container. The devices 10 may be connected to the network using wired or wireless communication. For example, the devices 10 may use wireless communication such as WiFi™, Zigbee™, Bluetooth™, 6LoWPAN etc., may use short range communication such as radio frequency communication (RFID) or near field communication (NFC), or may use cellular networks, such as 3G, 4G, 5G etc. The network may connect numerous different devices, each device using different or the same methods of communication. When the devices are virtual devices, in some embodiments they may be hosted on the same physical device as the network management module. In such cases, the communications between the virtual devices and the network management module may be handled by a virtual network hosted on the same physical device.

As illustrated in FIG. 1, a network management module 40 receives operation data requests 1 from the devices 10 and in response, disseminates operation data 2 to the devices 10.

According to one embodiment, a network management module 40 is provided for a network and disseminates operation data 2 to the devices 10 connected to the network. For example, the network may be a home network of a user and each device may be deployed by the user within their home environment. According to another embodiment, the network may be a business/university network and each device may be deployed as part of the business/university. More than one network management module may be provided to service a network.

The devices 10 may be connected to a cloud server (not illustrated) and may receive data from the server such as firmware/software updates, and/or may transfer data to the server. A request for operation data 1 is sent from a device 10 to the network management module 40. The operation data request may be a request for an user's response to policy requests, such as whether to allow the device to access the user's data, whether to allow the device to transmit the user data to the device manufacturer/server, whether to allow the device to share the user data with third parties, for what purposes the user data can be used for, whether to allow the device to download a firmware update etc. and/or configuration requests, such as requests for user preferences etc. The network management module 40 determines whether a response to the operation data request 1 can be derived from the user's 30 previous responses to requests for operation data. When the network management module 40 is able to determine a response, then the network management module 40 sends the response 2 to the requesting device without requiring the user to respond to the operation data request. For example, a request for operation data 1 may be a request to allow the device to access the user's data. The network management module 40 determines whether the user 30 has previously agreed/disagreed to allow the device/other devices to access the user's data. The network management module 40 then sends a response 2 to the device. The response 2 is derived from the determination as to whether the user 30 has previously agreed/disagreed to allow the device/other devices to access the user's data. For example, when the user has previously agreed to allow the device to access the user's data, the response 2 indicates that the device is allowed to access the user data. Consequently, the user is not required to agree to the same/similar requests numerous times and the number of requests sent to the user is reduced when compared to known systems.

However, when the network management module 40 is unable to determine a response to the request for operation data 1, for example, when the user has not previously agreed/disagreed to allow the device/other devices to access the user's data, the network management module 40 sends a request 3 for an user's response to the user 30. The user provides a response 4 to the network management module 40, which then sends a response 2 to the requesting device 10.

The network management module 40 sends a request 3 for an user's response to a user interface. The user interface may be a web page accessible by the user, for example via an user device 20 such as a computer, tablet or smart phone etc. Alternatively, the user interface may be an application provided at the user's device 20.

FIG. 2A illustrates a communication flow diagram of a method described herein. A device 10 sends a request 101 for operation data to a network management module 40. The network management module 40 comprises a logic 50 for determining how to respond to the operation data request 101. The logic 50 provides at least one query 102 to a repository 60 for data relating to the operation data request 101. The repository 60 comprises data indicative of the user's responses to previous operation data requests. The repository 60 determines whether any data is available in the repository 60 relating to the query request 102 and provides a query response 103 to the query request 102 to the logic 50. The query response 103 may indicate that there is no data in the repository 60 relating to the operation data request, or the query response 103 may comprise data indicative of the user's response to previous operation data request(s) which relate to the operation data request 101. The data may be indicative of the user's response to previous, similar and/or identical, operation data request(s) and may comprise the user's responses to more than one data request.

It may take several queries, all derived from the operation data request 101, to determine that there is/is not data in the repository 60 relating to the operation data request 101. For example, the operation data request 101 may be received from a smart lightbulb. The logic 50 may provide a first query to the repository 60 such as “are there prior consents for lightbulbs?”. If the query response 103 indicates that there is no data in the repository 60 relating to the first query, then the logic 50 may provide a second query to the repository 60 such as “are there prior consents for manufacturer X?”.

Based on the query response 103 received, the logic 50 determines whether it is able to provide a response to the operation data request 101 to the device. The query response 103 illustrated in FIG. 2A indicates that there is no data in the repository 60 relating to the operation data request, or comprises data indicative of the user's response(s) to previous operation data request(s) which relate to the operation data request 101, but which the logic 50 determines is not sufficient for it to provide a response to the operation data request 101. Therefore, the logic 50 determines that, based on the query response 103, it is unable to provide a response to the operation data request 101. Consequently, the logic 50 transmits a request 104 for a user response 105 to a user 30, via a user interface. When the logic 50 receives a user response 105, it provides to the repository 60 user response data 106 indicative of the user response 105. The logic 50 also transmits to the device 10 an operation data response 107A to the device's operation data request 101. The operation data response 107A is derived from the user response 105.

In some embodiments, when the logic 50 is deriving a user response request 104 from the operation data request 101 the scope of the request may be modified, or additional options provided to the user 30. For example, when the device 10 is a smart lightbulb, the user response request 104 may allow the user 30 to specify that the user response 105 may be applied to any smart lightbulb. Alternatively or in addition, the user response request 104 may allow the user 30 to specify that the response may be applied to any device from the same manufacturer, or to all future requests of the same type. It will be apparent to one of ordinary skill in the art that modification or the provision of additional options may be applied to different ways of classifying devices (for example, additional options may be applied by usage type, such as specifying that the response may be applied to all kitchen appliances). Such modification or the addition of options provided to the user 30 in the user response request 104 may increase the chance of the logic 50 being able to provide responses to operation data requests 101 from other devices 10 without having to provide a user response request 104 to the user 30. This is described in more detail below.

In some embodiments, multiple query responses 103 to multiple queries 102 may be examined before the logic 50 determines it is unable to provide a response to the operation data request 101. This may be more appropriate when the logic 50 is capable of processing operation data requests 101 for multiple types or classes of device, or processing operation data requests 101 based on the manufacturer of the device 10. For example, the logic 50 may receive an operation data request 101 from a smart lightbulb 10. In response, the logic 50 may provide a query 102 to the repository 60 requesting operation data relating to the device type: i.e. smart lightbulb. When the query response 103 indicates that the repository does not contain operation data related to that device type, the logic 50 may provide a further query 102 to the repository 60 for operation data related to the manufacturer of the smart lightbulb.

In some embodiments, the repository 60 may be part of the network management module 40, while in other embodiments it may be separate.

FIG. 2B illustrates another communication flow diagram of a method described herein. A device 10 sends a request 101 for operation data to a network management module 40. The logic 50 of the network management module 40 provides at least one query 102 to a repository 60 for data relating to the operation data request 101. The repository 60 determines whether any data is available in the repository 60 relating to the query 102 and provides a query response 103 to the logic 50. The query response 103 illustrated in FIG. 2B comprises data indicative of the user's response(s) to previous user response request(s) 104 which relate to the operation data request 101, and which the logic 50 determines is sufficient for it to provide a response to the operation data request 101. Consequently, the logic 50 transmits to the device 10 a response 107B to the device request 101. The response 107B to the device's operation data request 101 is derived from the data indicative of the user's response(s) 105 to a previous user response request(s) 104 which relate to the operation data request 101.

The query 102 provided to the repository 60 may not be the same as the operation data request 101 received from the device 10. The logic 50 processes the request 101 and determines the query 102. According to one embodiment, the query 102 may comprise a plurality of parts, a plurality being one or more. For example, the request 101 may be a request for the user to approve the terms and conditions of the device, the terms and conditions having multiple parts that each requires a response.

FIG. 2C illustrates another communication flow diagram of a method described herein, wherein the logic 50 processes the request 101 and determines the query 102 to comprise two queries, query sub-request 102A and query sub-request 102B. The repository 60 determines whether any data is available in the repository 60 relating to the query sub-request 102A and query sub-request 102B and provides a query response 103 to the logic 50. The query response 103 comprises data indicative of the user's response(s) to previous user response request(s) which relate to the query sub-request 102A (response 103A) and the query sub-request 102B (query response 103B). The logic 50 then determines, based on the query response 103 (103A, 103B) whether it is able to provide a response to the operation data request 101. It may be that the logic 50 is unable to provide a response to the whole operation data request 101. For example, the query response 103 may comprise data 103A indicative of the user's response(s) to previous user response request(s) which relate to the query sub-request 102A and may comprise data 103B indicating that there is no data in the repository 60 relating to the query sub-request 102B. Alternatively, it may be that the data 103B indicative of the user's response(s) to previous user response request(s) which relate to the query sub-request 102B is not adequate to determine a response to the query sub-request 102B.

When the logic module 50 is unable to provide a response to the whole operation data request 101, the logic module 50 transmits a request 104B for a user response to a user 30, via a user interface. In FIG. 2C, the user response request 104B relates to the query sub-request 102B. Similar to when the logic provides a query to the repository, the request for a user response may also comprise a plurality of sub-requests which require an user's response. When the logic 50 receives a user response 105B, it provides to the repository 60 data 106B indicative of the user response 105B. The logic 50 also transmits to the device 10 an operation data response 107 to the whole operation data request 101. The operation data response 107 to the device's operation data request 101 is derived from the data indicative of the user's response(s) to previous operation data request(s) which relate to the query sub-request 102A and the user response 105 to the query sub-request 102B.

In some embodiments, one or more of the plurality of repository queries (102) may be provided to the repository 60 after a previous query response has been provided to the logic 50. For example query 102B may be provided to the repository 60 after the query response 103A has been provided to the logic 50. In some embodiments, a combination of providing some queries after previous responses, and providing groups of queries before at least some query responses may be used.

As stated above, with reference to FIGS. 2A, 2B and 2C, the query response 103 may comprise data indicative of the user's response(s) to previous user response requests. The user response requests being derived from operation data requests. The logic 50 processes the query response 103 and determines the operation data response 107 to be sent to the device 10. Consequently, the query response 103 received from the repository may not be the same as the operation data response 107 sent to the device. Furthermore, the logic 50 processes the user response 105 and determines the operation data response 107 to be sent to the device 10 and the user response data 106 to be provided to the repository 60. Consequently, the response 105 received from the user may not be the same as the operation data response 107 sent to the device or the user response data 106 provided to the repository.

FIG. 3 illustrates schematically a method for propagating operation data to one or more devices. The method starts at step S200 when a request for operation data is received at the network management module 40. The logic 50 of the network management module 40 determines and provides at least one query to the repository at step S210. As discussed above, the query is determined based on the received request for operation data and may comprise one or more query sub-requests. At step S220, the logic 50 receives a response to the query from the repository. The response to the query may comprise data indicative of the user's response(s) to previous user response request(s) which relate to the operation data request received at step S200 and/or may comprise data indicating that there is no data in the repository that relates to the operation data request. When the query comprises more than one query sub-request which requires a response, the response to the query may comprise data indicative of the user's response(s) to previous user response request(s) which relate to part of the operation data request received at step S200 and data indicating that there is no data in the repository that relates to another part of the operation data request received at step S200.

The logic 50 then determines whether it can provide a response to the operation data request based on the response received from the repository at step S230. When it is established that a response to the operation data request can be determined based on the query response received from the repository, the method moves to step S270 and the logic 50 generates and provides a response to the device.

According to one embodiment, when a response to an operation data request is negative, i.e. when a response to the operation data request can be determined based on the response received from the repository, but the response denies the operation data request, then the network management module 40 may generate and provide a response to the device at step S270, refusing the device's operation data request. Alternatively, the network management module 40 may be configured not to respond to the operation data request, such that without a response from the logic module 50, the device is not able to perform the operation for which it required a response to the operation data request. According to this embodiment, at step S270, the logic module provides a response to the device at step S270 by not transmitting a response to the device.

When it is established that a response to the operation data request cannot be determined based on the query response received from the repository, the method moves to step S240. The response received from the repository may comprise data indicative of the user's response(s) to previous user response request(s) which relate to the operation data request. However, the logic 50 may determine that a response to the operation data request cannot be determined based on the response from the repository. Alternatively, the response from the repository may comprise data indicating that there is no data in the repository that relates to the operation data request.

At step S240, the logic 50 of the network management module 40 generates and transmits a request for user inputs to the user. The operation data request received from the device may not be the same as the request for user inputs sent to the user. For example, the operation data request may be “can I share data with my manufacturer?”, whereas the request sent to the user may be “can any device share any data with its manufacturer?”.

At step S250 a user response is received. The network management module 40 provides the user response to the repository at step S260 and generates and transmits a response to operation data request to the device at step S270. The user response provided to the repository may not be the same as the user response received at step S250, the user response provided to the repository may be derived from the user response received at step S250 or may be data indicative of the user response received at step S250. Furthermore, the response to the operation data request provided to the device at step S270 may not be the same as the user response received at step S250, the response to operation data request may be derived from the user response received at step S250 or may be data indicative of the user response received at step S250.

According to another embodiment steps S260 and S270 may be performed at substantially the same time. According to another embodiment, step S270 may be performed before step S260.

As discussed above, a response to an operation data request may be denial of the operation data request. When the user response received at step S250 refuses the operation data request, then the network management module 40 provides the user response to the repository at step S260. At step S270, the network management module 40 may generate and transmit a response to the device, refusing the device's operation data request. Alternatively, at step S270, the network management module 40 may be configured to provide a response to the device by not transmitting a response to the operation data request, such that without a response from the logic 50, the device 10 is not able to perform the operation for which it required a response to the operation data request.

The logic 50 of the network management module 40 receives operation data requests from multiple different devices and the content of each operation data request may vary from device to device. The logic 50 processes each operation data request and generates a query to provide to the repository. As stated above, the query to be provided to the repository may be different from the received operation data requests.

The logic 50 processes the operation data request and, if applicable, separates it into sub-requests, each sub-request requiring a user response. For example, the operation data request may be a request for the user's approval of a device's terms and conditions. A device's terms and conditions may comprise multiple different terms and conditions, each which require a response, consequently, the logic 50 processes the terms and conditions and separates then into sub-requests. According to another example, the operation data request may be a request for user configuration preference data. A device's configuration data request may comprise multiple different configuration aspects, each which requires a response. Consequently, the logic module processes the request for user configuration preference data and separates it into sub-requests. When the operation data request comprises only one request requiring a user response, the logic does not separate the operation data request into sub-requests.

The logic then generates the query to be sent to the repository. When the request has been separated into more than one operation data sub-request, at least one query sub-request for each sub-request is generated by the logic. The query sub-request may not be the same as the operation data sub-request to which it relates. For example, the request received from the device may be “can I share data with my manufacturer x?”, whereas the query sent to the repository may be “has the user consented to share data with manufacturer x?”. Alternatively or in addition, the query sent to the repository may be “has the user consented for devices to share data with their respective manufacturers?”

The operation data sub-requests or operation data request (when there is only one request in the operation data request) may comprise a classification of importance of the operation data sub-request or operation data request to the device. For example, an operation data sub-request/request may be classified as “critical” indicating that without the user's consent to the sub-request/request, the device will not be able to function. In addition, an operation data sub-request/request may be classified as “non-critical” indicating that without the user's consent to the sub-request/request, the device will still be able to function. There may be other classifications assigned to the operation data sub-requests/request between “critical” and “non-critical”, for example “limited functionality” indicating that the device 10 will be able to function if the operation data request is denied, but that some features of the device 10 may be disabled. The operation data request 101 from the device contains the classification of importance of the operation data request. When the logic separates the operation data request into more than one operation data sub-request, (if present) the logic includes the classification in the sub-requests.

The classification of the operation data request/sub-requests may also be used to determine whether the user should be contacted for a response. According to one embodiment, the user may indicate, via the user interface, different responses to be generated by the logic 50 based on the classification of the operation data request/sub-requests. For example, the user may indicate when they require to be contacted for a response and when they are content for the network management module to determine a response. The user may define that a “critical” request/sub-request indicates that the user should always be contacted for a response, even when a response can be determined from the data stored in the repository, whereas a “non-critical” operation data request/sub-request indicates that a user does not need to be contacted for a response when a response can be determined from the data stored in the repository. Alternatively, the user may define that a classification of “critical” indicates that the user should be contacted for a response only when the logic 50 determines from the query response 103 that the operation data request should be denied. The classification of the request/sub-requests may be used by the logic 50 to determine which request/sub-requests are to be sent as a query to the repository and which request/sub-requests are to be sent to the user interface for a user response. Furthermore, according to one embodiment, the user may indicate, via the user interface, predefined user responses to requests. For example, the user may define for each request stored at the repository a user response, such as:
always deny request regardless of classification;
always accept request regardless of classification;
always transmit a user request regardless of classification;
accept request if it is above a specified important level (i.e. accept if “critical”);
deny request if it is below a specified important level (i.e. deny if “non-critical”);
ask the user again if request is above a specified importance level (i.e. ask the user again if “critical”, deny if “non-critical”);
accept request if it is at or above importance level A and transmit a user request when it is below importance level A;
accept request if it is above importance level A, ask user if request is above importance level B, deny if request is below importance level B, where importance level A is greater than importance level B (i.e. accept if “critical”, ask the user again if “limited functionality”, deny if “non-critical”).

In its simplest form, the repository is a database comprising data indicative of an user's response to previous requests. It is the logic 50 which processes each operation data request and generates the appropriate query for the repository. According to one embodiment, the repository may comprise a database of requests and associated responses, either as a whole request or as a hash of the request.

If present in the repository, the repository will respond to a query with data relating to the device request. The data relating to the device request may comprise data indicative of an user's previous response to the same query/query sub-request, and/or data indicative of an user's previous response to similar queries/query sub-requests. For example, a query/query sub-request may request a user's consent to data sharing between the device and the manufacturer of the device. The repository may not comprise data indicative of the user's response to the query/query sub-request, however, the repository may comprise data indicative of the user's responses to a similar query/query sub-request, such as a similar request regarding a different device of the same type and a different manufacturer, or a similar request regarding a different device and the same manufacturer, or even a similar request which is worded slightly differently etc.

Each response stored at the repository may have an associated user permission. When providing their response to any request from the network management module, the user may also provide their permission as to whether the response may be applied to other requests and propagated to different devices in the network. A permission indication derived from the user permission, if present, is stored in the repository. The permission indication may be associated with one or more user responses stored in the repository. A user permission may comprise an end date, such that after the end date the response is no longer propagated to devices in the network. Alternatively the end date may be communicated to the device such that it's granted the permission for a limited amount of time. Examples of an associated user permission may be:
response may be propagated to all other devices;
response may be propagated to a subset of the devices, such as all devices of the same class—wherein a class may be: all devices of the same type (e.g. light bulbs), all devices of the same user; all devices having the same association (e.g. kitchen appliances etc.);
response may be propagated to all devices by the same manufacturer;
response may be propagated to only this device;
response has an end date of **/**/****.

The user may access and review/edit/add/remove the associated user permission(s) via the user interface discussed above. The user may also indicate via the user interface when a request should be sent to the user. For example, the user may indicate that when a term/condition is identical to another term/condition that the user has previously responded to, then that user's response may be used to derive the response. However, the user may specify that when a term/condition is similar to another term/condition that the user has previously responded to, then the user should be sent a request. The similarity between a term/condition may be rated by the network management module, and whether the user requires to be sent a request depends on the similarity. For example, when a term/condition is considered to be 98% similar, then the user may not require a request to be sent, however when a term/condition is considered to be 56% similar the user may require a request to be sent.

According to another embodiment, the user may indicate that a response provided in relation to a request from a specific device manufacturer may only be used to derive the response for other requests from devices from the same manufacturer, and/or for devices from other manufacturers.

Furthermore, the user may revoke or amend a response which has been transmitted to one or more devices, by accessing the user interface. When the user indicates that a response is to be revoked or amended, the network management module may transmit a revocation/amendment notice to all devices, to which the revocation/amendment is relevant. Alternatively, when the user indicates that a response is to be revoked or amended, the network management module may remove the user response from the repository, so that the user response cannot be used for future responses or may amend the user response in the repository.

According to one embodiment, a set of default user responses may be provided in the repository for a first instance use of the network management module. Alternatively, the repository may comprise no user responses on first use, such that the user is sent user requests when device requests are received and their responses used to populate the repository.

According to one embodiment, the network management module may access one or more repositories, each repository comprising a different user's responses. For example, when a request for operation data is received from a device requiring a response from an user A, the network management module provides a request to repository A associated with user A, and when a request for operation data is received from a device requiring a response from an user B, the network management module provides a request to repository B associated with user B. The one or more repositories may be separate virtual repositories provided at the same repository. According to this embodiment, the device request for operation data received from the device may comprise an user identifier identifying the user of the device. This may be useful when the network management module is provided for a network and more than one user has devices on the network.

According to another embodiment, the device request for operation data comprises an user identifier identifying the user of the device and the repository stores response data indicative of a plurality of user responses to prior user requests, each user response associated with an user identifier identifying the user who provided the response.

According to one embodiment, the logic may determine the user of the device, based on data stored in the repository.

According to another embodiment, there may be hierarchies of users defined at the network management module, such that when a request for operation data is received from a device requiring a response from an user A, the network management module determines whether a response from user A should be provided or whether a response from another user, further up the hierarchy should be provided. This embodiment may be useful to enable a parent to override a child's responses and set parental controls. For example, when a request for operation data is received from a device requiring a response from user A (a child), the network management module may determine that a response from user B (the parent) is required, such that the request is sent to the repository for a response associated with user B's identifier/the request is sent to repository B associated with user B. This embodiment may also be useful to enable a business to define responses for all devices provided to employees etc.

According to another embodiment, where a device does not comprise a user identifier identifying the user of the device, or where a device comprises multiple owners/operators, e.g. a shared toy, the logic determines, based on data stored in the repository, an user associated with the device to which the request should be sent/the repository of the user associated with the device to which the request should be sent. For example, the repository may contain an entry for a device indicating that third party data requests must be responded to by user A (i.e. a parent). Therefore, when a request from the device for permission to automatically update itself and to share data with selected third parties is received, the logic determines a repository query to be provided to the repository associated with user A and/or transmits a user request for a user response to user A's device relating to the third party aspect of the request, and the logic determines a repository query to be provided to the repository associated with the child using the device and/or transmits a user request for a user response to the child's device relating to the update aspect of the request.

The repository responds to each query from the logic with data indicative of the user's response to the same and/or similar requests, if present in the repository. The logic then processes the response from the repository to determine if a response to the operation data request can be derived. The logic also applies any associated user permissions to the response. For example, the data indicative of the user's response, provided by the repository, may have an associated user permission indicating that the response may only be propagated to devices having the same manufacturer. The logic module determines whether the request came from a device by the same manufacturer as the response. When the request came from a device having the same manufacturer as the response provided by the repository, then the data indicative of the user's response may be used to derive a response to be transmitted to the device. However, when the request came from a device having a different manufacturer from that of the response provided by the repository, then the data indicative of the user's response may not be used to derive a response to be transmitted to the device. In this instance, the logic sends a request to the user for a response. According to another example, the data indicative of the user's response, provided by the repository, may have an associated user permission indicating that the response may not be propagated to any device after the end date. The logic determines whether the end date has passed. When the end date has not passed, the logic determines whether the data indicative of the user's response may be used to derive a response to be transmitted to the device. However, when the end date has passed, the logic module determines that the data indicative of the user's response may not be used to derive a response to be transmitted to the device. In this instance, the logic sends a request to the user for a response.

The response from the repository may also be associated with a confidence value, indicating the relevance of the response to the request. For example, a response to an identical request would have a higher confidence value than a response to a similar request etc. The logic may use the associated confidence values in order to derive the response and/or determine whether a response cannot be derived.

When a standardised approach is used to write the operation data requests by manufacturers and/or when each operation data request/sub request is associated with a serial number/code/version number etc., then the network management module and repository may readily identify each operation data request/sub-request and determine whether an user's response to the operation data request/sub-request has already been provided. The use of serial numbers/codes/version numbers may be particularly useful when only one or two of multiple terms and conditions have been changed. In addition, a serial number/code/version number may also indicate when a term or condition has been altered or is unchanged. Furthermore, other standardised fields within the operation data request may also be used to indicate whether the request/sub-request is critical, non-critical etc.

According to one embodiment, a machine-readable version of the operation data request is provided to the network management module, such that the network management module and repository may readily identify each operation data request/sub-request and determine whether an user's response to the operation data request/sub-request has already been provided.

According to one example, a device may require a response to its updated terms and conditions. The device requires a response to the entire updated terms and conditions comprising ten terms and conditions, and therefore the operation data request comprises the entire updated terms and conditions. However, eight of the ten terms and conditions are unchanged and have previously been responded to by the user, when responding to the previous version of the terms and conditions. The logic processes the operation data request and transmits a query to the repository comprising ten query sub-requests, one for each term and condition. The repository responds with data indicative of the user's response to nine of the query sub-requests. As mentioned above, eight of the ten terms and conditions have previously been responded to by the user, so data indicative of the user's response to these eight terms and conditions is provided in the repository and is provided to the logic by the repository. In addition, the repository identifies a user response to one of the other two terms and conditions which the user provided for a similar request, so the repository also provides data indicative of this user response to the logic. The logic processes the response from the repository and determines that a response is required from the user regarding only one of the sub-requests. Therefore, the logic sends a request for an user's response to the one sub-request. Although the user is still required to provide a response to the one sub-request, the amount of responses required by the user are reduced when compared to known systems. In addition, since data indicative of the user's response is saved to the repository, the user should not be required to respond to the same request again.

According to another example, a plurality of devices of the same type may be provided in a network, and each device requires a response to the same device request for operation data, such as a plurality of smart lightbulbs requiring a response to updated terms and conditions. According to this example, a device request for operation data is sent to the network management module. The network management module determines how to respond to the device request and provides a response to each of the plurality of devices. The response may be provided to each device at the same time, or at different times. In addition, although a request for an user's response may be required in relation to the request for operation data, the user is not required to respond in relation to each of the plurality of devices request for operation data.

According to another example, a device may require user configuration preference data. The device 10 is a smart light bulb. The device 10 sends a request for operation (configuration) data to the network management module 40. The request being a request for an user's preference for lightbulb colour. The logic 50 determines that the light bulb 10 is provided in the master bedroom and derives a query to be sent to the repository, such as “what colour should the light bulb be in the master bedroom”? The repository comprises data, such as a list of lightbulb colours set by room as well as a default colour if the room is not known. The repository responds with a colour associated with the master bedroom, and the logic determines a response to be sent to the smart lightbulb.

According to another embodiment, the network management module may be provided in communication with one or more virtual devices, each virtual device having isolated software boundaries. The network management module and the virtual device(s) may be provided in the same or in separate physical entities.

In a health care situation it is often useful for data to be shared between multiple entities, such as doctors, medicine manufacturers, health insurance providers, medical device manufactures, healthcare agencies etc. For example, a doctor may provide information to medicine manufacturers as to which drugs are being prescribed, the information being provided without personal user data, such that the manufacturer can estimate future demands. In addition, it may be advantageous for a medical insurance company to be able to inform a doctor when a medicine being prescribed is/is not covered by an user's medical insurance. However, an user's healthcare data is very sensitive. Consequently, a user is required to provide their consent before their data is shared between different devices/entities. For example, an user may consent to their data from a healthcare monitoring device being provided to their doctor (e.g. their insulin levels etc.) but not third parties; may consent to data regarding operation of a healthcare monitoring device being provided to the device manufacturer, but not their personal data being provided to the device manufacturer; may consent to “cleansed” or “anonymised” health care data (i.e. the user's health care data provided without the user's personal data required to identify the user) being provided to healthcare agencies for statistical purposes; and may deny any of their personal data being provided to health insurance providers. A doctor's office may comprise multiple devices for collecting data, such as: medical devices (e.g. a blood pressure cuff etc.), a voice recognition device configured to collect data regarding different drug names when mentioned, an input device for receiving inputs from the doctor etc. The doctor's office may also comprise multiple devices which would like access to the collected data, such as devices collecting data for drug companies, devices collecting data for insurance companies, devices collecting data for healthcare agencies etc. The devices which would like access to the collected data may be the same devices as those which collected the data or may be different devices. Each device in the doctor's office is connected to a network and is capable of communicating with a network management module. The network management module may be provided at the doctor's office or may be connected to the network and capable of communication with the devices via the network. The network management module provides operation data to the devices within the doctor's office in accordance with the user's preferences and responses.

Each device may be a separate device, or one or more of the devices may be virtual devices (i.e. isolated software modules) provided at the same physical device. In addition, the network management module may be a virtual device, and one or more of the virtual devices and the virtual network management module may be provided at the same physical device.

As discussed above, with reference to FIGS. 2A, 2B, 2C and 3, when a device requests operation data, the network management module determines, whether a response can be derived from the user's previous responses, and when a response can be derived, provides a response to the device. The device may then operate in accordance with the operation data request, for example, the device may request the distribution of user health data to medicine manufacturers. The user may have previously provided consent to only send “cleansed data”, consequently the network management module provides the device with the user's consent, and the device only provides “cleansed” data to the medicine manufacturer. According to another example, a medical device may request to share diagnostic data regarding the functioning of the medical device with the device manufacturer. The user may have previously provided consent to only send device diagnostic data to the manufacturer, not user data, consequently the network management module provides the device with the user's consent, and the device only provides device diagnostic data to the manufacturer.

Since the network management module is provided in a doctor's office, the network management module may receive user identification data from an application provided on each user's device, when they enter the doctor's office, such that the network management module may retrieve data from the repository which corresponds to the user currently in the doctor's office. According to another embodiment, the doctor's office may have predefined responses, such that no user personal data is shared with any of the devices, only cleansed data is provided. When an user's response is not known, a request is sent to the user's device as described herein.

According to one embodiment, the response data stored in the repository may be categorised based on the user's responses to prior user requests to share the user's data. For example, the response data indicative of user responses to prior user requests regarding sharing the user's personal data may be categorised as “personal data”; the response data indicative of user's responses to prior user requests regarding sharing the user's diagnostic data may be categorised as “diagnostic data”; the response data indicative of user's responses to prior user requests regarding sharing the devices performance data may be categorised as “manufacturer data”; the response data indicative of user's responses to prior user requests regarding environmental data may be categorised as “environmental data”; the response data indicative of user's responses to prior user requests regarding the user's configuration preferences may be categorised as “configuration data” etc. When a repository query requests data relating to a device request, the repository may identify response data in the same category as being similar, and provide that similar data to the logic. Therefore, when a user has previously responded to a device request from a first device, only allowing their personal data to be shared with their doctor, the logic will respond to a similar query from a second device, only allowing the user's personal data to be shared with their doctor.

Each category of data may have an associated sharing scope defining whether the data may be shared with, for example: only the user's doctor; only the device manufacturer; predefined third parties etc. In addition, the sharing scope may define how the data is used, for example, the user may permit their data to be used to support the operation of the device, or help fix bugs in the device's operations, but may not permit their data to be used to better target advertising at them.

The user may access and review/edit/add/remove their responses stored in the repository via the user interface discussed above.

FIG. 4 illustrates schematically a network management module 40 as described herein. The network management module 40 comprises at least one processor 70 coupled to at least one memory 80. The memory 80 may comprise program memory storing computer program code to implement the methods described herein, and working memory. The processor 70 may comprise processing logic to process data and generate output signals in response to the processing.

The network management module 40 also comprises a communication module 90 configured to receive data or data signals from one or more external devices (such as devices 10, a user interface on a user device 20), and to transmit data or data signals to one or more devices (such as devices 10, a user interface on a user device 20). According to one embodiment, the repository 60 may be a software module provided at the memory 80 and run on the at least one processor 70.

The memory 80 may comprise a volatile memory such as random-access memory (RAM), for use as temporary memory whilst the network management module 40 is operational. Additionally, the memory 80 may comprise non-volatile memory such as Flash, read only memory (ROM) or electrically erasable programmable ROM (EEPROM), for storing data, programs, or instructions received or processed by the network management module 40.

The network management module 40 also comprises a logic 50 configured to determine responses to operation data requests. The logic 50 is configured to formulate queries to be provided to the repository 60 based on received operation data requests; determine whether a response to an operation data request can be provided based on a response received from the repository 60/a user's response; formulate a response to an operation data request based on a response received from the repository 60/a user's response to be transmitted to the device; formulate requests for a user response to be transmitted to a user based on received operation data requests and/or a response received from the repository; formulate data indicative of the user response to be transmitted to the repository 60 based on the user response. The logic 50 may be configured to communicate with the memory 80, the repository 60 and the communication module 90. According to one embodiment, the logic 50 may be a software module provided at the memory 80 and run on the at least one processor 70.

The repository 60 may be a component of the network management module 40 as illustrated in FIG. 4A. Alternatively, the repository 60 may be a separate component accessible by the network management module 40 over a network, as illustrated in FIG. 4B. For example, the repository 60 may be provided at a remote cloud server.

The network management module 40 may be provided as a module of a router, or may be a separate device.

Although the above description refers to a user, the “user” may not be a single person. For example, the user may be a business, and the network management module may be provided for the devices of the business. In this scenario, the user is a person representing the business and may not necessarily be one single person.

According to one embodiment, each user of a network may have a separate account. The request for operation data may comprise an indicator identifying the user who owns the device, and/or the repository may comprise an indicator identifying each user's responses, such that the network management module may determine a response to an operation data request which is specific to an user and/or so that a first user's responses are not provided when requiring a second, different, user's response. This embodiment may be advantageous, for example, when a network management module is provided in an user's home network, and the users of the network are multiple members of a family. This embodiment may also be advantageous when the network management module is provided for a business having multiple different users, such that whenever a user having an account connects to the network, their responses/preferences are applied. For example, whenever a user hires a car from business X, the users preferences such as “favourite pre-set radio stations” are retrieved by the network management module and applied to the car's audio system.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

As will be appreciated from the foregoing specification, techniques are described providing a computer implemented method for propagating operation data relating to operation of at least one device.

According to further techniques when the logic is unable to determine based on the at least one received response to the at least one repository query how to respond to the device request, the at least one received response to the at least one repository query comprises data indicative that there is no data in the repository relating to the device request.

According to further techniques the response to the device request provided to the device comprises not transmitting a response to the device request when the device request is denied.

According to further techniques the response to the device request provided to the device comprises transmitting a denial of the device request to the device.

According to further techniques the device request comprises a classification indicative of an importance of the request for operation data to the device's operation.

According to further techniques the classification is used by the logic when determining how to respond to the device request.

According to further techniques the logic determines to: always deny the device request regardless of classification; always accept the device request regardless of classification; accept the device request when the classification of the device request is at or above a specified classification and deny the device request when the classification of the device request is below the specified classification; always transmit a user request regardless of classification; transmit a user request when the classification of the device request is at or above a specified classification and deny the device request when the classification of the device request is below the specified classification; accept the device request when the classification of the device request is at or above a first specified classification, and transmit a user request when the classification of the device request is below the first specified classification; accept the device request when the classification of the device request is at or above a first specified classification, transmit a user request when the classification of the device request is below the first specified classification and at or above a second specified classification and deny the device request when the classification of the device request is below the second specified classification.

According to further techniques the response data stored in the repository comprises an associated user permission, and wherein the associated user permission is used by the logic when determining how to respond to the device request.

According to further techniques the received user response to the user request comprises an associated user permission, and wherein the new data indicative of the user response comprises a permission indication derived from the associated user permission.

According to further techniques the associated user permission comprises one or more of: an indication that the user response may be propagated to all other devices; an indication that the user response may be propagated to all devices of the same class; an indication that the user response may be propagated to all devices by the same manufacturer; an indication that the user response has an end date.

According to further techniques the device request for operation data comprises an user identifier identifying an user of the device, and wherein the repository query comprises the user identifier and requests data indicative of the user's identified by the user identifier responses to prior user requests, and wherein the user request for the user response is transmitted to the user identified by the user identifier.

According to further techniques the device request for operation data comprises an user identifier identifying an user of the device, wherein the logic is further configured to determine a user associated with the device, based on data stored in the repository, wherein the repository query comprises an indication of the associated user and requests data indicative of the associated user's responses to prior user requests, and wherein the user request for the user response is transmitted to the associated user.

According to further techniques upon receiving the response data the logic determines an associated confidence value, the associated confidence value indicating a determined relevance of the response to the device request.

According to further techniques one or more of the at least one device comprises a virtual device.

According to further techniques the response to the device request is provided to a plurality of devices.

According to further techniques the response data stored in the repository is categorised based on the user's responses to prior user requests to share data.

According to further techniques each category comprises an associated sharing scope, the sharing scope defining how the data may be shared.

According to further techniques the response data is categorised as one of: personal data; diagnostic data; manufacturer data environmental data; configuration data.

According to further techniques, when the logic is able to determine based on at least one received response to the at least one repository query how to respond to the device request, the method further comprises: providing to the device a response to the device request derived from the at least one received response to the at least one repository query.

According to further techniques, the device request comprises a plurality of requests for operation data, and the at least one received response to the at least one repository query comprises: data indicative of user responses to prior user requests relating to one or more of the plurality of requests for operation data, and data indicative that there is no data in the repository relating to one or more of the other plurality of requests for operation data.

According to further techniques, the logic is able to determine based on one or more of the at least one received response to the at least one repository query how to respond to one or more of the plurality of requests for operation data, the logic is unable to determine based on one or more of the at least one received response to the at least one repository query how to respond to one or more of the other plurality of requests for operation data, and the network management module provides a response to the device request derived from the at least one received response to the at least one repository query and the user response.

According to further techniques, the at least one received response to the at least one repository query comprises data indicative of user responses to prior user requests which relate to the device request.

According to further techniques, the at least one repository query is derived from the received device request for operation data.

Techniques are also described providing a network management module for propagating operation data relating to operation of at least one device.

According to further techniques, the logic is further configured to determine the at least one repository query based on the device request for operation data.

According to further techniques, the logic is further configured to determine the request for user inputs based on the device request for operation data and/or the received response to the repository query.

According to further techniques, the network management module comprises the repository.

According to further techniques, the repository is provided remote from the network management module.

1. A computer implemented method for propagating operation data relating to operation of at least one device, the method comprising:
receiving, at a network management module, a device request for operation data in relation to operation of one or more devices, from a device, the network management module comprising logic to determine how to respond to the device request by:
providing at least one repository query to a repository for data relating to the device request, the repository configured to store response data indicative of user responses to prior user requests derived from prior device requests; and
when the logic is unable to determine based on at least one received response to the at least one repository query how to respond to the device request, transmitting, to a user interface, a user request for a user response, wherein the user request is derived from the device request; and
in response to receiving the user response to the user request, providing to the repository new data indicative of the user response and providing to the device a response to the device request derived from the user response;
wherein the device request comprises a classification indicative of an importance of the request for operation data to the device's operation.

2. The computer implemented method of claim 1, wherein when the logic is unable to determine based on the at least one received response to the at least one repository query how to respond to the device request, the at least one received response to the at least one repository query comprises data indicative that there is no data in the repository relating to the device request.

3. The computer implemented method of claim 1, wherein the response to the device request provided to the device comprises not transmitting a response to the device request when the device request is denied or transmitting a denial of the device request to the device.

4. (canceled)

5. (canceled)

6. The computer implemented method of claim 1, wherein the classification is used by the logic when determining how to respond to the device request.

7. The computer implemented method of claim 1, wherein the logic determines to: always deny the device request regardless of classification; always accept the device request regardless of classification; accept the device request when the classification of the device request is at or above a specified classification and deny the device request when the classification of the device request is below the specified classification; always transmit a user request regardless of classification; transmit a user request when the classification of the device request is at or above a specified classification and deny the device request when the classification of the device request is below the specified classification; accept the device request when the classification of the device request is at or above a first specified classification, and transmit a user request when the classification of the device request is below the first specified classification; accept the device request when the classification of the device request is at or above a first specified classification, transmit a user request when the classification of the device request is below the first specified classification and at or above a second specified classification and deny the device request when the classification of the device request is below the second specified classification.

8. The computer implemented method of claim 1, wherein the response data stored in the repository comprises an associated user permission, and wherein the associated user permission is used by the logic when determining how to respond to the device request.

9. The computer implemented method of claim 1, wherein the received user response to the user request comprises an associated user permission, and wherein the new data indicative of the user response comprises a permission indication derived from the associated user permission.

10. The computer implemented method of claim 8, wherein the associated user permission comprises one or more of: an indication that the user response may be propagated to all other devices; an indication that the user response may be propagated to all devices of the same class; an indication that the user response may be propagated to all devices by the same manufacturer; an indication that the user response has an end date.

11. The computer implemented method of claim 1, wherein the device request for operation data comprises an user identifier identifying a user of the device, wherein the repository query comprises the user identifier and requests data indicative of the user identified by the user identifier responses to prior user requests, and wherein the user request for the user response is transmitted to the user identified by the user identifier.

12. The computer implemented method of claim 1, wherein the logic is further configured to determine a user associated with the device, based on data stored in the repository, wherein the repository query comprises an indication of the associated user and requests data indicative of the associated user's responses to prior user requests, and wherein the user request for the user response is transmitted to the associated user.

13. The computer implemented method of claim 1, wherein upon receiving the response data the logic determines an associated confidence value, the associated confidence value indicating a determined relevance of the response to the device request.

14. The computer implemented method of claim 1, wherein one or more of the at least one device comprises a virtual device.

15. The computer implemented method of claim 1, wherein the response to the device request is provided to a plurality of devices.

16. The computer implemented method of claim 1, wherein the response data stored in the repository is categorized based on the user's responses to prior user requests to share data, optionally wherein each category comprises an associated sharing scope, the sharing scope defining how the data may be shared, optionally wherein the response data is categorized as one of: personal data; diagnostic data; manufacturer data environmental data; configuration data.

17. (canceled)

18. (canceled)

19. The computer implemented method of claim 1, further comprising:
when the logic is able to determine based on at least one received response to the at least one repository query how to respond to the device request, providing to the device a response to the device request derived from the at least one received response to the at least one repository query.

20. A non-transitory computer readable storage medium comprising computer program code for performing the method of claim 1.

21. A network management module for propagating operation data relating to operation of at least one device, the network management module comprising:
a communication module for receiving a device request, created by the device, for operation data in relation to operation of one or more devices; and
logic for providing, to a repository, at least one repository query for data relating to the device request, the repository configured to store repository data indicative of user responses to prior user requests derived from prior device requests, for determining how to respond to the device request based on at least one received response to the at least one repository query, and for providing, to a user interface, a user request for a user response to the device request when the logic is unable to determine how to respond to the device request;
wherein, in response to receiving the user response to the user request, the logic provides to the repository new data indicative of the user response and provides to the device a response to the device request derived from the user response;
wherein the device request comprises a classification indicative of an importance of the request for operation data to the device's operation.

22. The network management module of claim 21, wherein the logic is further configured to determine the at least one repository query based on the device request for operation data or to determine the request for user inputs based on the device request for operation data and/or the received response to the repository query.

23. (canceled)

24. The network management module of claim 21, comprising the repository or wherein the repository is provided remote from the network management module.

25. (canceled)

26. A system for propagating operation data relating to operation of at least one device, the system comprising:
at least one device; and
a network management module for receiving a device request for operation data in relation to operation of one or more devices, from at least one device, the network management module comprising logic to determine how to respond to the device request by:
providing at least one repository query to a repository for data relating to the device request, the repository comprising response data indicative of user responses to prior user requests derived from prior device requests; and
when the logic is unable to determine based on at least one received response to the at least one repository query how to respond to the device request, providing, to a user interface, a user request for a user response derived from the device request; and
in response to receiving the user response to the user request, providing to the repository new data indicative of the user response and providing to the at least one device a response to the device request derived from the user responses;
wherein the device request comprises a classification indicative of an importance of the request for operation data to the device's operation.
